(19) United States
(12) Patent Application Publication
(10) Pub. No.: US 2008/0319960 A1
(43) Pub. Date: Dec. 25, 2008

(54) Information searching method, information searching system and inputting device thereof

(76) Inventor: Yuan-Jung Chang, Hsinchuang City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/819,007

(22) Filed: Jun. 25, 2007

(51) Int. Cl. G06F 17/30

(52) U.S. Cl. 707/4; 707/E17.136

(57) ABSTRACT

An information searching method is used for searching for information on the Internet. Firstly, an information searching system is provided. The information searching system has a hot key. Secondly, whether the hot key is enabled is determined. If the hot key is enabled, the information searching system links to a search engine, and duplicates a pre-selected key data to a search column of the search engine to generate a search result. Thereby, information on the Internet that is relative to the key data can be acquired easily and quickly.

### BACKGROUND OF THE INVENTION

1. Field of the Invention

The present invention relates to an information searching method. In particular, this invention relates to an information searching method and a system that searches information on the Internet.

2. Description of the Related Art

Recently, because Internet technology has developed so rapidly and the bandwidth most users connect to the Internet has become wider, computers are now linked to webpages based all over the world via the Internet. How to find information provided over the Internet is a top issue for users. Search engines provide a service to find out webpages that are relative to a user's search.

In general, the operation of a search engine can be divided into three types, including full-text search engines, directory search engines, and META search engines. Google and Yahoo are respectively a full-text search engine and a directory search engine. When a user searches from information on the Internet, the user links to the search engine and inputs key words to perform the search function. The search engine then displays the search results on the user's screen.

As information provided over the Internet becomes more and more plentiful, information found by search engines grow more popular as a reference source for users. When users use an application program to process documents or navigate information on a webpage and need to retrieve the content, the user has to open a new navigator, input the address of the search engine, input key words for the retrieved text data, graphic data or picture data in the search column, and execute a search to obtain the required information. Following the complex steps described above to search for required information is rather time-consuming.

### SUMMARY OF THE INVENTION

One particular aspect of the present invention is to provide an information searching method, an information searching system, and an inputting device thereof. The inputting device is used as an interface for the information searching system. It enables a hotkey on the inputting device to control the information searching system to automatically link to a search engine and search the Internet information that is relative to the selected key words. Therefore, it is convenient for the user to search for information on the Internet.

The present invention discloses an information searching method that is used for searching information on the Internet. Firstly, an information searching system is provided. The information searching system has a hot key. Secondly, whether the hot key is enabled is determined. If the hot key is enabled, the information searching system links to a search engine, and duplicates a pre-selected key data to a search column of the search engine to generate a search result.

The present invention also discloses an information searching system. The information searching system includes a hot key, a control module, an embedded controller, and an operating system. The control module is coupled to the hot key. When the hot key is enabled, the control module generates a make code. The embedded controller receives the make code to generate a usage code. The operating system receives the usage code and responds to the usage code. The operating system drives the information searching system to link with a search engine, and duplicates a pre-selected key data to a search column of the search engine to generate a search result.

The present invention further discloses an inputting device that is used as an interface for the information searching system. The information searching system has an operating system. The inputting device includes a hot key, and a control module. The control module is coupled to the hot key. When the hot key is enabled, the control module generates a make code. The information searching system responds to the make code and generates a usage code. The usage code is delivered to the operating system. The operation system responds to the usage code and drives the information searching system to link with a search engine, and duplicates a pre-selected key data to a search column of the search engine to generate a search result.

For further understanding of the invention, reference is made to the following detailed description illustrating the embodiments and examples of the invention. The description is only for illustrating the invention and is not intended to be considered limiting of the scope of the claim.

### BRIEF DESCRIPTION OF THE DRAWINGS

The drawings included herein provide a further understanding of the invention. A brief introduction of the drawings is as follows:

FIG. 1 is a schematic diagram of the information searching system of the present invention;

FIG. 2 is a schematic diagram of the appearance of the information searching system of one embodiment of the present invention;

FIG. 3 is a flow chart of the information searching method of the present invention; and

FIG. 4 is a flow chart of the information searching method of one embodiment of the present invention.

### DETAILED DESCRIPTION OF THE PREFERRED EMBODIMENTS

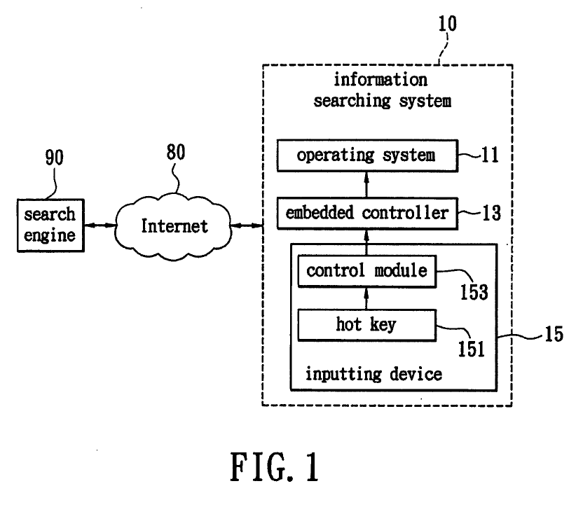

The present invention uses a hot key to control and automatically search for information on the Internet. Reference is made to FIG. 1, which shows a schematic diagram of the information searching system 10 of the present invention. The information searching system 10 can be a desktop computer, a portable computer, a PDA, or a portable communication device. As shown in FIG. 1, the information searching system 10 includes an operating system 11, an embedded controller 13, and an inputting device 15. The inputting device 15 includes a hot key 151 and a control module 153. The inputting device 15 is used as an operation interface of the information searching system 10. The inputting device 15 can be a keyboard or a mouse.

The information searching system 10 of the present invention uses a computer system as a basic structure. The information searching system 10 in FIG. 1 is used to illustrate the present invention. Anyone who is skilled at using the computer system knows that the information searching system 10 also includes a CPU, a memory, and a screen to store and execute the operating system, the application program, and hardware driving program.

When the hot key 151 located on the inputting device 15 is enabled (such as by being pressed), the operating system 11 is controlled to execute a specified process. The specified process includes driving the information searching system 10 to link with a search engine 90 via the Internet 80, and duplicating a pre-selected key data to a search column of the search engine to execute the search function and generate a search result. The search engine 90 can be a general search engine (such as a search engine provided by Goggle, or Yahoo), or a specified search engine (such as a search engine for a paper database). Therefore, when a user wants to search for text or a picture, the user can rapidly obtain the information that is relative to the key data from the Internet, without opening a navigator, linking the navigator to a search engine, and inputting the key data, such as text, or a picture, into the search column of the search engine.

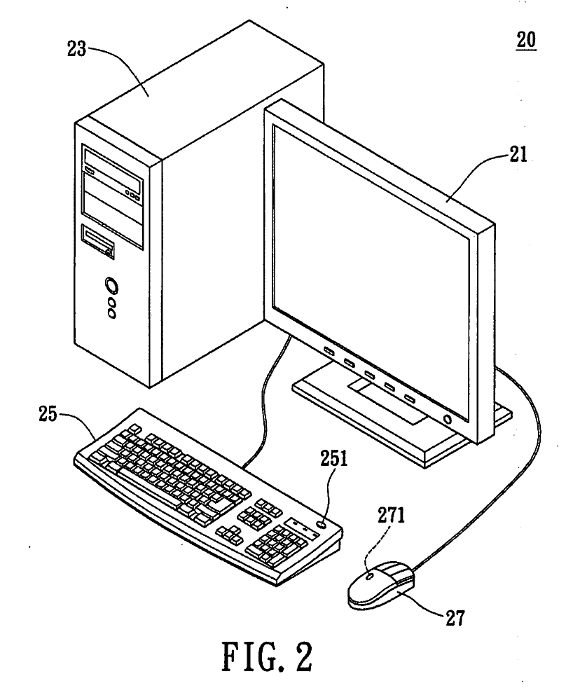

Reference is made to FIG. 2, which shows a schematic diagram of the appearance of the information searching system 20 of one embodiment of the present invention. A desktop computer is used as an example for the information searching system 20. The information searching system 20 includes a screen 21, a host 23, and two inputting devices 25, 27. The inputting devices 25, 27 are a keyboard and a mouse. The screen 21 and the inputting device 25 are connected with the host 23 and used as a displaying interface and an operating interface of the information searching system 20. The inputting devices 25, 27 respectively have a hot key 251, 271. The hot keys 251, 271 are respectively located at a proper location on the inputting devices 25, 27. The location and type of the hot keys 251, 271 in FIG. 2 is merely an example, and is not used to limit the scope of the present invention.

In FIG. 1, the operating system 11 is an executing and operating platform for the application program and executes a hardware driving program to make the information searching system 10 operate normally. Currently, a Microsoft Windows operating system is the most commonly used operating system. The inputting device 15 is coupled with the embedded controller 13. The embedded controller 13 is coupled with the operating system 11. The control module 153 includes a microcontroller. The control module 153 uses the pre-stored firmware in the microcontroller to control the inputting device 15. Similarly, the embedded controller 13 is also stored with a firmware to control the inputting device 15. The driving program for the inputting device 15 is installed in the operating system 11 in advance, and can be executed by the operating system 11 to support the operation of the inputting device 15.

The inputting device 15 is a keyboard that is used as an example to illustrate the operation of the information searching system 10. The control module 153 and the embedded controller 13 respectively have a keyboard control firmware stored therein. The operating system 11 also has a keyboard driving program to support the operation of the keyboard. The control module 153 is controlled by the firmware to scan the keys on the keyboard. When a key on the keyboard is pressed and released, the control module 153 outputs a make code and a break code that correspond to the pressed key. The embedded controller 13 receives the make code and the break code outputted from the control module 153, and responds to the make code to generate an inner code that is delivered to the operating system 11. The operating system 11 analyzes the operating status of the keyboard according to the inner code to execute the follow-up steps.

The control module 153 and the embedded controller 13 have a firmware that matches the type and function of the inputting device 15 stored therein. When the hot key 151 on the inputting device 15 is enabled, the control module 153 responds to the hot key 151 and generates a make code that means the hot key 151 has been operated. The embedded controller 13 receives the make code, and responds to the make code to generate a usage code. The usage code is delivered to the operating system 11 to deliver the information that the hot key 151 has been enabled. After the operating system 11 receives the usage code, the operating system 11 responds to the usage code and executes the specified process.

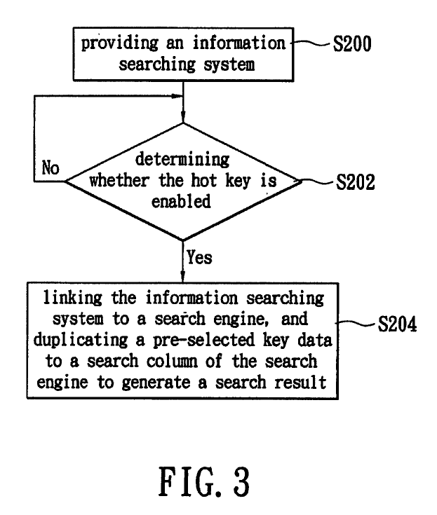

Reference is made to FIG. 3, which shows a flow chart of the information searching method of the present invention. The information searching method is suitable for searching the Internet for information. The information searching system is referred to in FIG. 1.

Firstly, an information searching system 10 is provided. The information searching system 10 has a hot key 151 (S200).

Secondly, whether the hot key 151 is enabled is determined (S202).

If the hot key 151 is enabled, the operating system 11 drives the information searching system 10 to link with a search engine 90 via the Internet 80, and duplicates a pre-selected key data to a search column of the search engine to generate a search result (S204).

The key data is selected by the user in advance via the operating platform of the operating system 11. For example, when a user executes an application program (such as Word, Excel, or Internet Explorer) and wants to retrieve the content, the user uses the keyboard or the mouse to select the content and use it as the key data. The key data can be text data, graphic data, picture data, or a combination thereof.

In the steps of the information searching method, the procedure of S204 is configured in the firmware of the control module 153 and the embedded controller 13 in advance, and is installed in the driving program of the operating system 11. Therefore, the information searching system 10 can determine whether the hot key 151 has been enabled, and automatically execute the procedure of step S204.

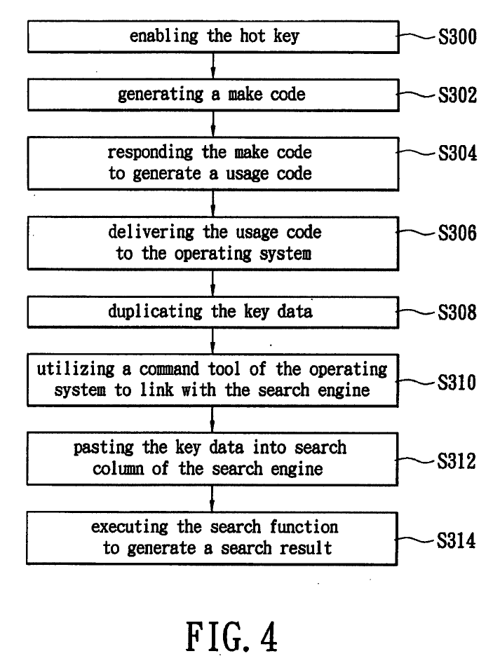

Reference is made to FIG. 4, which shows a flow chart of the information searching method of one embodiment of the present invention. After the hot key 151 has been enabled (S300), the control module 153 responds to the hot key 151 to generate a make code (S302).

Secondly, the embedded controller 13 receives the make code and responds to the make code to generate a usage code (S304).

The usage code is delivered to the operating system 11. The operating system 11 responds to the usage code to execute the specified procedure. The specified procedure executed by the operating system 11 can utilize the functions provided by the Windows Application Programming Interface to open and control the relative programs, and execute detailed instructions for each of the programs (S306).

The specified procedure includes the following steps. Firstly, the pre-selected key data is duplicated to a platform of the operating system 11 (S308).

Secondly, the command tool of the operating system 11 is utilized to input the address of the search engine 90 to make the information searching system 10 link with the search engine 90 (S310).

The duplicated key data is pasted to the search column of the search engine (S312).

Finally, the searching function of the search engine is executed to generate the searching result (S314).

The information searching method and the information searching system uses the hot key located on the inputting device to cooperate with the relative firmware and driving program to execute the specified procedure. When the user wants to retrieve content, the user merely needs to select the content and press the hot key to control the operating system. Thereby, the information searching system automatically links with the search engine to display the information that is relative to the key data. Compared to the prior art, it is easy to search for information on the Internet by using the present invention. The working efficiency is increased.

The description above only illustrates specific embodiments and examples of the invention. The invention should therefore cover various modifications and variations made to the herein-described structure and operations of the invention, provided they fall within the scope of the invention as defined in the following appended claims.

What is claimed is:

1. An information searching method, used for searching for information on the Internet, the steps comprising:
providing an information searching system, wherein the information searching system has a hot key;
determining whether the hot key is enabled or not; and
linking the information searching system to a search engine, and duplicating a pre-selected key data to a search column of the search engine to generate a search result, if the hot key is enabled.

2. The information searching method as claimed in claim 1, wherein the step of generating a search result further comprises:
generating a make code;
responding to the make code to generate a usage code; and
delivering the usage code to an operating system of the information searching system.

3. The information searching method as claimed in claim 1, wherein the step of generating a search result further comprises:
utilizing a command tool of an operating system of the information searching system to link with the search engine.

4. The information searching method as claimed in claim 1, wherein the step of generating a search result further comprises:
duplicating the pre-selected key data to an operating system platform of the information searching system; and
pasting the key data into the search column of the search engine.

5. The information searching method as claimed in claim 1, wherein the key data is text data, graphic data, picture data, or a combination thereof.

6. The information searching method as claimed in claim 1, wherein the hot key is located on an inputting device, and the inputting device is an operation interface of the information searching system.

7. An information searching system, comprising:
a hot key;
a control module coupled to the hot key, wherein when the hot key is enabled, the control module generates a make code;
an embedded controller receiving the make code to generate a usage code; and
an operating system receiving the usage code and responding to the usage code to drive the information searching system to link with a search engine via the Internet and duplicate a pre-selected key data to a search column of the search engine to generate a search result.

8. The information searching system as claimed in claim 7, wherein the control module has a firmware, and the control module is controlled by the firmware to respond to the hot key to generate the make code.

9. The information searching system as claimed in claim 7, wherein the embedded controller has a firmware, and the embedded controller is controlled by the firmware to respond to the make code to generate the usage code.

10. The information searching system as claimed in claim 7, further comprising an inputting device, wherein the inputting device is an operation interface of the information searching system, and the hot key and the control module are located on the inputting device.

11. The information searching system as claimed in claim 10, wherein the inputting device is a keyboard or a mouse.

12. The information searching system as claimed in claim 7, wherein the information searching system is a computer, a PDA, or a portable communication device.

13. An inputting device, used as an interface of an information searching system, the information searching system has an operating system, the inputting device comprising:
a hot key; and
a control module coupled to the hot key, wherein when the hot key is enabled, the control module generates a make code;
wherein the information searching system responds to the make code and generates a usage code, the usage code is delivered to the operating system, the operation system responds to the usage code and drives the information searching system to link with a search engine via the Internet, and duplicates a pre-selected key data to a search column of the search engine to generate a search result.

14. The inputting device as claimed in claim 13, wherein the control module has a firmware, and the control module is controlled by the firmware to respond to the hot key to generate the make code.

15. The inputting device as claimed in claim 13, wherein the information searching system further comprises an embedded controller, the embedded controller has a firmware, and the embedded controller is controlled by the firmware to respond to the make code to generate the usage code.

16. The inputting device as claimed in claim 13, wherein the inputting device is a keyboard or a mouse.

17. The inputting device as claimed in claim 13, wherein the information searching system is a computer, a PDA, or a portable communication device.
